(19) United States
(12) Patent Application Publication
(10) Pub. No.: US 2026/0222943 A1
(43) Pub. Date: Jul. 30, 2026

(54) Protection from False Base Stations in L1/L2-Triggered Mobility (LTM) by User Equipment

(71) Applicant: Telefonaktiebolaget LM Ericsson (publ), Stockholm (SE)

(72) Inventors: Mattias Bergström, Sollentuna (SE); Antonino Orsino, Kirkkonummi (FI)

(21) Appl. No.: 19/141,228

(22) PCT Filed: Jan. 8, 2024
(86) PCT No.: PCT/SE2024/050012

§ 371 Date: Jun. 19, 2025

Related U.S. Application Data
(60) Provisional application No. 63/438,020, filed on Jan. 10, 2023.

(51) Int. Cl. H04W 36/08; H04W 36/00

(52) U.S. Cl. CPC H04W 36/08; H04W 36/0038

(57) ABSTRACT

Embodiments include methods for a user equipment (UE) configured for L1/L2-triggered mobility (LTM) in a radio access network (RAN) Such methods include receiving the following from a first RAN node: respective configurations for one or more LTM candidate target cells, 5 and one or more security tokens associated with the LTM candidate target cells. Such methods include receiving an LTM cell switch command that indicates a first one of the LTM candidate target cells and includes a security token. Such methods include comparing the security token received in the LTM cell switch command and the security token associated with the configuration of the first LTM candidate target cell, thereby detecting a match or a mismatch, and performing 0 one or more of the following based on detecting a mismatch: sending the first RAN node a report about the detected mismatch, and aborting or refraining from initiating an LTM cell switch procedure. 5 FIG. 4 is selected for publication. 0 5

### TECHNICAL FIELD

The present disclosure relates generally to the field of wireless networks, and more specifically to improving mobility of user equipment (UEs) across multiple cells in a wireless network, particularly mobility based on layer-1 (L1) and/or layer-2 (L2) procedures that incur less delay than conventional layer-3 mobility procedures.

### BACKGROUND

Currently the fifth generation (5G) of cellular systems is being standardized within the Third-Generation Partnership Project (3GPP). NR is developed for maximum flexibility to support multiple and substantially different use cases. These include enhanced mobile broadband (eMBB), machine type communications (MTC), ultra-reliable low latency communications (URLLC), side-link device-to-device (D2D), and several other use cases.

FIG. 1 illustrates a high-level view of an exemplary 5G network architecture, consisting of a Next Generation Radio Access Network (NG-RAN, 199) and a 5G Core (5GC, 198). The NG-RAN can include one or more gNodeB's (gNBs) connected to the 5GC via one or more NG interfaces, such as gNBs (100, 150) connected via respective interfaces (102, 152). More specifically, the gNBs can be connected to one or more Access and Mobility Management Functions (AMFs) in the 5GC via respective NG-C interfaces and to one or more User Plane Functions (UPFs) in 5GC via respective NG-U interfaces. The 5GC can include various other network functions (NFs), such as Session Management Functions (SMF).

Although not shown, in some deployments the 5GC can be replaced by an Evolved Packet Core (EPC), which conventionally has been used together with a fourth generation (4G) Long-Term Evolution (LTE) Evolved UMTS RAN (E-UTRAN). In such deployments, gNBs (e.g., 100, 150) can connect to one or more Mobility Management Entities (MMEs) in EPC 198 via respective S1-C interfaces. Similarly, gNBs can connect to one or more Serving Gateways (SGWs) in EPC via respective NG-U interfaces.

In addition, the gNBs can be connected to each other via one or more Xn interfaces, such as Xn interface (140) between gNBs (100, 150). The radio technology for the NG-RAN is often referred to as “New Radio” (NR). With respect to the NR interface to UEs, each of the gNBs can support frequency division duplexing (FDD), time division duplexing (TDD), or a combination thereof. Each of the gNBs can serve a geographic coverage area including one or more cells and, in some cases, can also use various directional beams to provide coverage in the respective cells.

NG RAN logical nodes (e.g., gNB 100) may include a Central Unit (CU or gNB-CU, e.g., 110) and one or more Distributed Units (DU or gNB-DU, e.g., 120, 130). CUs are logical nodes that host higher-layer protocols and perform various gNB functions such controlling the operation of DUs. DUs are decentralized logical nodes that host lower layer protocols and can include, depending on the functional split option, various subsets of the gNB functions. Each CU and DU can include various circuitry needed to perform their respective functions, including processing circuitry, communication interface circuitry (e.g., transceivers), and power supply circuitry.

A gNB-CU connects to one or more gNB-DUs over respective F1 logical interfaces (e.g., 122 and 132 shown in FIG. 1). However, a gNB-DU can be connected to only a single gNB-CU. The gNB-CU and its connected gNB-DU(s) are only visible to other gNBs and the 5GC as a gNB. In other words, the F1 interface is not visible beyond gNB-CU.

Dual connectivity (DC) was introduced in LTE Rel-12. In DC operation, a UE in RRC_CONNECTED state consumes radio resources provided by at least two different network nodes connected to one another with a non-ideal backhaul. Several DC (or more generally, multi-connectivity) arrangements are also supported in 5G/NR. These include NR-DC that is like LTE DC except that both network nodes use the NR interface to communicate with the UE, as well as various multi-RAT DC (MR-DC) involving both LTE and NR access by the same UE. More generally, one node acts as a master node (MN) providing the UE's master cell group (MCG) and another node acts as a secondary node (SN) providing the UE's secondary cell group (SCG), with at least the MN being connected to a core network (e.g., EPC or 5GC).

Each of the CGs includes one MAC entity, a primary cell (PCell), and optionally one or more secondary cells (SCells). The term “Special Cell” (or “SpCell” for short) refers to the PCell of the MCG or the PCell of the SCG (also referred to as “PSCell”) depending on whether the UE's MAC entity is associated with the MCG or the SCG, respectively. In non-DC operation (e.g., carrier aggregation, CA), SpCell refers to the PCell. An SpCell is always activated and supports physical UL control channel (PUCCH) transmission and contention-based random access by UEs.

When the UE moves between the coverage areas of two cells, a serving cell change needs to be performed at some point. Currently, serving cell change is triggered by layer 3 (L3, e.g., RRC) measurements and involves RRC signaling to change PCell and/or PSCell (e.g., when dual connectivity is configured), as well as release/add SCells (e.g., when CA is configured). For example, a handover command is sent by an RRCReconfiguration message that includes a reconfigurationWithSync information element (IE).

Currently, L3 inter-cell mobility involves complete layer 2 (L2) and layer 1 (L1, i.e., PHY) resets, leading to longer latency, increased signaling overhead, and longer interruptions than for intra-cell beam switching. To address these issues, NR Rel-18 includes a Work Item on NR mobility enhancements, which includes a feature referred to as L1/L2 based inter-cell mobility, L1/L2 triggered mobility (LTM), or lower layer-triggered mobility. This work item is further described in 3GPP document RP-213565. A goal of Rel-18L1/L2 mobility (or LTM) enhancements is to facilitate serving cell change via L1/L2 signaling to reduce latency, signaling overhead, and interruptions associated with conventional L3 inter-cell mobility.

A basic principle of LTM is that the UE is pre-configured, by the network, with one configuration per LTM candidate target cell. Based on UE-reported measurements, the network then triggers UE execution of LTM cell switch by transmitting a lower layer message (to the UE, which then switches to the indicated LTM candidate target cell and connects to the cell (which then becomes the target cell).

### SUMMARY

Even so, a UE performing LTM must ensure that any LTM cell switch command is received from an authorized and/or legitimate RAN node. One approach is that each LTM candidate target cell configuration provided to the UE includes a security token, the source of which is the RAN node serving that LTM candidate target cell. The RAN node also includes the security token in any subsequent LTM cell switch command to the UE for that LTM candidate target cell. If the later security token matches the earlier security token for the same cell, the UE can assume the LTM cell switch command is valid since only a legitimate RAN node would be able to provide the correct security token.

However, an illegitimate RAN node may send a UE multiple LTM cell switch commands with random security tokens, which have some probability of matching the valid security token previously received by the UE. A probabilistic match will cause the UE to perform the LTM cell switch procedure to the cell served by a legitimate RAN node (i.e., that earlier provided the configuration), even though that node did send the command. This can cause various problems, issues, and/or difficulties, such as overload conditions in cells and failed LTM operations by UEs. Accordingly, embodiments of the present disclosure address these and other problems, issues, and/or difficulties, thereby facilitating secure and predictable L1/L2 mobility between cells in a RAN (e.g., NG-RAN).

Some embodiments of the present disclosure include methods (e.g., procedures) for a UE configured for L1/L2-triggered mobility (LTM) in a RAN.

These exemplary methods can include receiving the following from a first RAN node via a serving cell: respective configurations for one or more LTM candidate target cells, and one or more security tokens associated with the LTM candidate target cells. These exemplary methods also include receiving an LTM cell switch command indicating a first one of the LTM candidate target cells. The LTM cell switch command includes a security token. These exemplary methods also include comparing the security token received in the LTM cell switch command and the security token associated with the configuration of the first LTM candidate target cell, thereby detecting a match or a mismatch between the compared security tokens. These exemplary methods also include performing one or more of the following operations based on detecting mismatch between the compared security tokens:
aborting or refraining from initiating the LTM cell switch procedure to the first LTM candidate cell, and
sending the first RAN node a report about the detected mismatch between the compared security tokens.

In some embodiments, each configuration includes an associated security token, which is independent of the security tokens of other configurations. In other embodiments, at least two of the configurations are associated with a common security token, which is received together with the at least two configurations.

In some embodiments, these exemplary methods also include determining that the LTM cell switch command is invalid based on a detected mismatch between the compared security tokens being one of the following:
an initial mismatch detected based on comparing security tokens; or
an Nth mismatch detected based on comparing security tokens, where N>1.

In some of these embodiments, determining that the LTM cell switch command is invalid is further based on receiving, from the first RAN node or a second RAN node, an indication that the LTM cell switch command indicating the first LTM candidate target cell is invalid, illegitimate, and/or unintended.

In some of these embodiments, these exemplary methods also include, after determining that the LTM cell switch command is invalid, receiving a subsequent LTM cell switch command that includes a further security token. In such embodiments, these exemplary methods also include determining that the subsequent LTM cell switch command is invalid based on the earlier determination that the LTM cell switch command is invalid.

In some of these embodiments, the subsequent LTM cell switch command indicates the first LTM candidate target cell and determining that the subsequent LTM cell switch command is invalid is independent of whether the further security token matches the security token associated with the configuration of the first LTM candidate target cell.

In other of these embodiments, the subsequent LTM cell switch command indicates a second one of the LTM candidate target cells and is received from a same RAN node as the LTM cell switch command. In such embodiments, determining that the subsequent LTM cell switch command is invalid is independent of whether the further security token matches the security token associated with the configuration of the second LTM candidate target cell.

In some embodiments, the one or more operations performed based on detecting a mismatch between the compared security tokens also include one or more of the following,:
discarding the LTM cell switch command;
maintaining the UE's connection with the first RAN node via the serving cell; and
releasing all LTM candidate target cells associated with a third RAN node, from which the LTM cell switch command including the mismatched security token was received.
In some embodiments, the report about the detected mismatch between the compared security tokens includes one or more of the following:
an identifier of the LTM cell switch command;
an identifier of the first LTM candidate target cell;
the security token received with the LTM cell switch command;
an identifier of a RAN node from which the UE received the LTM cell switch command; and
the security token associated with the configuration of the first LTM candidate target cell.

In some embodiments, these exemplary methods also include, after sending the report, receiving one or more of the following from the first RAN node,:
a further LTM cell switch command indicating the first LTM candidate target cell or a second one of the LTM candidate target cells;
one or more new security tokens to replace corresponding security tokens received with the configurations; and
an indication to release all of the configurations.
   In some of these embodiments, the one or more new security tokens have greater lengths or sizes than the corresponding security tokens being replaced.

In some embodiments, these exemplary methods also include, based on detecting a match between the compared security tokens, executing the LTM cell switch to the first LTM candidate target cell in accordance with the command.

Other embodiments include methods (e.g., procedures) for a RAN node configured to support L1/L2-triggered mobility (LTM) of UEs in the RAN.

These exemplary methods include sending the following to a UE via a serving cell:
respective configurations for one or more LTM candidate target cells, and one or more security tokens associated with the LTM candidate target cells. These exemplary methods also include subsequently receiving from the UE a report about a mismatch detected by the UE between the following: the security token associated with the configuration of a first one of the LTM candidate target cells, and a security token received by the UE in an LTM cell switch command from a second RAN node.

In some embodiments, each configuration includes an associated security token, which is independent of the security tokens of other configurations. In other embodiments, at least two of the configurations are associated with a common security token, which is sent together with the at least two configurations.

In some embodiments, the detected mismatch indicated by the report is one of the following:
an initial mismatch detected by the UE based on comparing security tokens; or
an Nth mismatch detected by the UE based on comparing security tokens, where N>1.

In some embodiments, the report about the detected mismatch between the compared security tokens includes one or more of the following:
an identifier of the LTM cell switch command received by the UE;
an identifier of the first LTM candidate target cell;
the security token received with the LTM cell switch command;
an identifier of a RAN node from which the UE received the LTM cell switch command; and
the security token associated with the configuration of the first LTM candidate target cell.

In some embodiments, these exemplary methods also include, based on the report about the detected mismatch, sending to the UE one or more of the following:
a further LTM cell switch command indicating the first LTM candidate target cell or a second one of the LTM candidate target cells;
one or more new security tokens to replace corresponding security tokens received with the configurations; and
an indication to release all of the configurations.
   In some of these embodiments, the one or more new security tokens have greater lengths or sizes than the corresponding security tokens being replaced.

In some embodiments, these exemplary methods also include, based on the report about the detected mismatch, sending one or more of the following to another network node or function (NNF):
an identifier of the LTM cell switch command received by the UE;
an identifier of the first LTM candidate target cell;
the security token received with the LTM cell switch command;
an identifier of a RAN node from which the UE received the LTM cell switch command; and
the security token associated with the configuration of the first LTM candidate target cell.

In some embodiments, the other NNF is one of the following: a centralized unit (CU) associated with the RAN node; an NNF in a core network coupled to the RAN; or an operations/administration/maintenance (OAM) system coupled to the RAN.

Other embodiments include UEs (e.g., wireless devices) and RAN nodes (e.g., base stations, eNBs, gNBs, DUs, etc.) configured to perform operations corresponding to any of the exemplary methods described herein. Other embodiments also include non-transitory, computer-readable media storing computer-executable instructions that, when executed by processing circuitry, configure such UEs and RAN nodes to perform operations corresponding to any of the exemplary methods described herein.

These and other embodiments described herein can provide various technical benefits and/or advantages. For example, embodiments can prevent an illegitimate RAN node from successfully guessing (e.g., through repeated attempts) a security token associated with an LTM cell switch command for a UE. Embodiments can also prevent a UE from responding to a correct guess after repeated attempts. In this manner, embodiments can facilitate predictable UE behavior in LTM execution and prevent overload conditions in cells served by legitimate RAN nodes due to actions by illegitimate RAN nodes.

These and other objects, features, and advantages of the present disclosure will become apparent upon reading the following Detailed Description in view of the Drawings briefly described below.

### BRIEF DESCRIPTION OF THE DRAWINGS

FIGS. 1-2 illustrate two high-level views of an exemplary 5G/NR network architecture.

FIG. 3 shows an exemplary configuration of NR user plane (UP) and control plane (CP) protocol stacks.

FIG. 4 shows an exemplary method (e.g., procedure) for a UE, according to various embodiments of the present disclosure.

FIG. 5 shows an exemplary method (e.g., procedure) for a RAN node, according to various embodiments of the present disclosure.

FIG. 6 shows a communication system according to various embodiments of the present disclosure.

FIG. 7 shows a UE according to various embodiments of the present disclosure.

FIG. 8 shows a network node according to various embodiments of the present disclosure.

FIG. 9 shows host computing system according to various embodiments of the present disclosure.

FIG. 10 is a block diagram of a virtualization environment in which functions implemented by some embodiments of the present disclosure may be virtualized.

FIG. 11 illustrates communication between a host computing system, a network node, and a UE via multiple connections, at least one of which is wireless, according to various embodiments of the present disclosure.

### DETAILED DESCRIPTION

Embodiments briefly summarized above will now be described more fully with reference to the accompanying drawings. These descriptions are provided by way of example to explain the subject matter to those skilled in the art and should not be construed as limiting the scope of the subject matter to only the embodiments described herein. More specifically, examples are provided below that illustrate the operation of various embodiments according to the advantages discussed above.

In general, all terms used herein are to be interpreted according to their ordinary meaning to a person of ordinary skill in the relevant technical field, unless a different meaning is expressly defined and/or implied from the context of use. All references to a/an/the element, apparatus, component, means, step, etc. are to be interpreted openly as referring to at least one instance of the element, apparatus, component, means, step, etc., unless explicitly stated otherwise or clearly implied from the context of use. The operations of any methods and/or procedures disclosed herein do not have to be performed in the exact order disclosed, unless an operation is explicitly described as following or preceding another operation and/or where it is implicit that an operation must follow or precede another operation. Any feature of any embodiment disclosed herein can apply to any other disclosed embodiment, as appropriate. Likewise, any advantage of any embodiment described herein can apply to any other disclosed embodiment, as appropriate.

Furthermore, the following terms are used throughout the description given below:
Radio Access Node: As used herein, a “radio access node” (or equivalently “radio network node,” “radio access network node,” or “RAN node”) can be any node in a radio access network (RAN) that operates to wirelessly transmit and/or receive signals. Some examples of a radio access node include, but are not limited to, a base station (e.g., gNB in a 3GPP 5G/NR network or an enhanced or eNB in a 3GPP LTE network), base station distributed components (e.g., CU and DU), a high-power or macro base station, a low-power base station (e.g., micro, pico, femto, or home base station, or the like), an integrated access backhaul (IAB) node, a transmission point (TP), a transmission reception point (TRP), a remote radio unit (RRU or RRH), and a relay node.
Core Network Node: As used herein, a “core network node” is any type of node in a core network. Some examples of a core network node include, e.g., a Mobility Management Entity (MME), a serving gateway (SGW), a PDN Gateway (P-GW), a Policy and Charging Rules Function (PCRF), an access and mobility management function (AMF), a session management function (SMF), a user plane function (UPF), a Charging Function (CHF), a Policy Control Function (PCF), an Authentication Server Function (AUSF), a location management function (LMF), or the like.
Wireless Device: As used herein, a “wireless device” (or “WD” for short) is any type of device that is capable, configured, arranged and/or operable to communicate wirelessly with network nodes and/or other wireless devices. Communicating wirelessly can involve transmitting and/or receiving wireless signals using electromagnetic waves, radio waves, infrared waves, and/or other types of signals suitable for conveying information through air. Unless otherwise noted, the term “wireless device” is used interchangeably herein with the term “user equipment” (or “UE” for short), with both of these terms having a different meaning than the term “network node”.
Radio Node: As used herein, a “radio node” can be either a “radio access node” (or equivalent term) or a “wireless device.”
Network Node: As used herein, a “network node” is any node that is either part of the radio access network (e.g., a radio access node or equivalent term) or of the core network (e.g., a core network node discussed above) of a cellular communications network. Functionally, a network node is equipment capable, configured, arranged, and/or operable to communicate directly or indirectly with a wireless device and/or with other network nodes or equipment in the cellular communications network, to enable and/or provide wireless access to the wireless device, and/or to perform other functions (e.g., administration) in the cellular communications network.
Node: As used herein, the term “node” (without prefix) can be any type of node that can in or with a wireless network (including RAN and/or core network), including a radio access node (or equivalent term), core network node, or wireless device. However, the term “node” may be limited to a particular type (e.g., radio access node, IAB node) based on its specific characteristics in any given context.

The above definitions are not meant to be exclusive. In other words, various ones of the terms may be explained and/or described elsewhere in the present disclosure using the same or similar terminology. Nevertheless, to the extent that such other explanations and/or descriptions conflict with the above definitions, the above definitions should control.

Note that the description given herein focuses on a 3GPP cellular communications system and, as such, 3GPP terminology or terminology similar to 3GPP terminology is oftentimes used. However, the concepts disclosed herein are not limited to a 3GPP system and can be applied to any communication system that may benefit from them.

FIG. 2 shows another high-level view of an exemplary 5G network architecture, including an NG-RAN (299) and a 5GC (298 ). As shown in the figure, the NG-RAN can include gNBs (e.g., 210a,b) and ng-eNBs (e.g., 220a,b) that are interconnected with each other via respective Xn interfaces. An ng-eNB is similar to a fourth generation (4G) Long-Term Evolution (LTE) eNB, except that it supports the Xn and NG interfaces rather than corresponding X2 and S1 interfaces.

The gNBs and ng-eNBs are also connected via the NG interfaces to the 5GC, more specifically to AMFs (e.g., 230a,b) via respective NG-C interfaces and to UPFs (e.g., 240a,b) via respective NG-U interfaces. Moreover, the AMFs can communicate with one or more policy control functions (PCFs, e.g., 250a,b) and network exposure functions (NEFs, e.g., 260a,b).

Each of the gNBs can support the NR radio interface including frequency division duplexing (FDD), time division duplexing (TDD), or a combination thereof. Each of ng-eNBs can support the 4G/LTE radio interface. Each of the gNBs and ng-eNBs can serve a geographic coverage area including one or more cells (e.g., 211a-b and 221a-b). Depending on the cell in which it is located, UEs (e.g., 205) can communicate with the gNB or ng-eNB serving that cell via the NR or LTE radio interface, respectively. Although FIG. 2 shows gNBs and ng-eNBs separately, it is also possible that a single NG-RAN node provides both LTE and NR functionality.

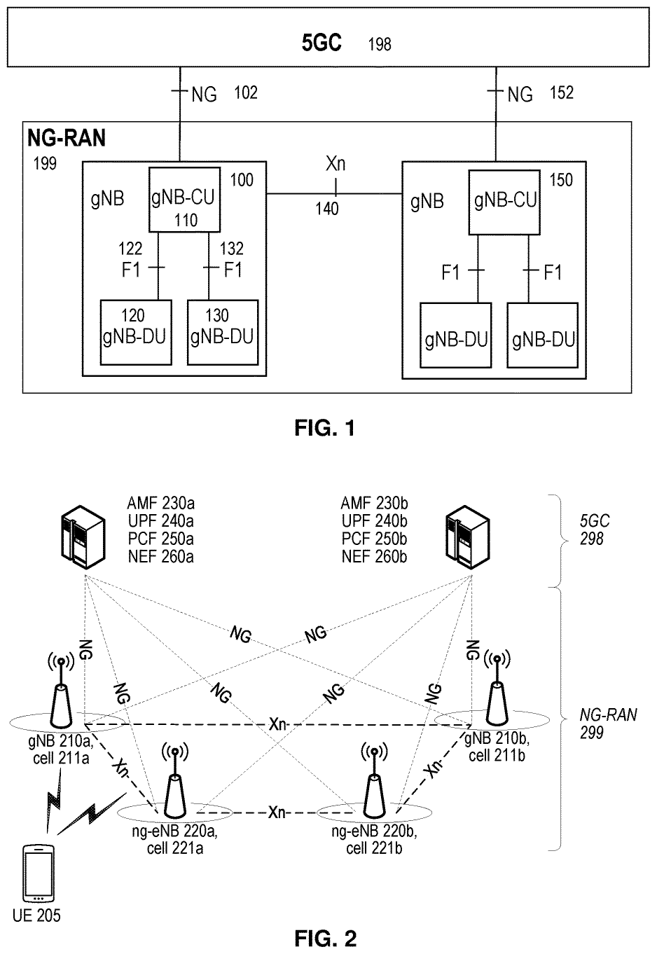

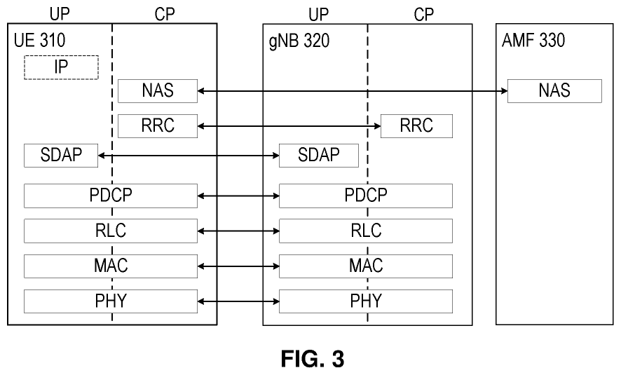

FIG. 3 shows an exemplary configuration of NR user plane (UP) and control plane (CP) protocol stacks between a UE (310), a gNB (320), and an AMF (330), such as those shown in FIGS. 1-2. The Physical (PHY), Medium Access Control (MAC), Radio Link Control (RLC), and Packet Data Convergence Protocol (PDCP) layers between the UE and the gNB are common to UP and CP. The PDCP layer provides ciphering/deciphering, integrity protection, sequence numbering, reordering, and duplicate detection for both CP and UP. In addition, PDCP provides header compression and retransmission for UP data.

On the UP side, Internet protocol (IP) packets arrive to PDCP as service data units (SDUs), and PDCP creates protocol data units (PDUs) to deliver to RLC. The Service Data Adaptation Protocol (SDAP) layer handles quality-of-service (QOS) including mapping between QoS flows and Data Radio Bearers (DRBs) and marking QoS flow identifiers (QFI) in UL and DL packets.

When each IP packet arrives, PDCP starts a discard timer. When this timer expires, PDCP discards the associated SDU and the corresponding PDU. If the PDU was delivered to RLC, PDCP also indicates the discard to RLC. The RLC layer transfers PDCP PDUs to the MAC through logical channels (LCH). RLC provides error detection/correction, concatenation, segmentation/reassembly, sequence numbering, reordering of data transferred to/from the upper layers. If RLC receives a discard indication from associated with a PDCP PDU, it will discard the corresponding RLC SDU (or any segment thereof) if it has not been sent to lower layers.

MAC provides mapping between LCHs and PHY transport channels, LCH prioritization, multiplexing into or demultiplexing from transport blocks (TBs), hybrid ARQ (HARQ) error correction, and dynamic scheduling (in gNB). PHY provides transport channel services to MAC and handles transfer over the NR radio interface, e.g., via modulation, coding, antenna mapping, and beam forming.

On the CP side, the non-access stratum (NAS) layer between UE and AMF handles UE/gNB authentication, mobility management, and security control. RRC sits below NAS in the UE but terminates in the gNB rather than the AMF. RRC controls communications between UE and gNB at the radio interface as well as the mobility of a UE between cells in the NG-RAN. RRC also broadcasts system information (SI) and performs establishment, configuration, maintenance, and release of DRBs and Signaling Radio Bearers (SRBs) and used by UEs. Additionally, RRC controls addition, modification, and release of carrier aggregation (CA) and dual-connectivity (DC) configurations for UEs, and performs various security functions such as key management. After a UE is powered ON it will be in the RRC IDLE state until an RRC connection is established with the network, at which time the UE will transition to RRC_CONNECTED state (e.g., where data transfer can occur). The UE returns to RRC IDLE after the connection with the network is released. In RRC_IDLE state, the UE's radio is active on a discontinuous reception (DRX) schedule configured by upper layers. During DRX active periods (also referred to as “DRX On durations”), an RRC_IDLE UE receives SI broadcast in the cell where the UE is camping, performs measurements of neighbor cells to support cell reselection, and monitors a paging channel on PDCCH for pages from 5GC via gNB. An NR UE in RRC_IDLE state is not known to the gNB serving the cell where the UE is camping. However, NR RRC includes an RRC_INACTIVE state in which a UE is known (e.g., via UE context) by the serving gNB. RRC_INACTIVE has some properties similar to a “suspended” condition used in LTE.

Seamless mobility is a key feature of 3GPP radio access technologies (RATs). In general, a network configures a UE to perform and report RRM measurements to assist network-controlled mobility decisions, such as for handover from a serving cell to a neighbor cell while the UE is in RRC_CONNECTED state. Seamless handovers ensure that the UE moves around in the coverage area of different cells without causing too many interruptions in data transmission.

The network can configure a UE in RRC_CONNECTED state to perform and report RRM measurements that assist network-controlled mobility decisions such as UE handover between cells, SN change, etc. The UE may lose coverage in its current serving cell (e.g., PCell in DC) and attempt handover to a target cell. Similarly, a UE in DC may lose coverage in its current PSCell and attempt an SN change. Other events may trigger other mobility-related procedures. A radio link failure (RLF) procedure is typically triggered in the UE when something unexpected happens in any of these mobility-related procedures. The RLF procedure involves interactions between RRC and lower layer protocols such as PHY (or L1), MAC, RLC, etc. including radio link monitoring (RLM) on L1.

The principle of RLM is similar in LTE and NR. In general, the UE monitors link quality of the UE's serving cell (i.e., SpCell) and uses that information to decide whether the UE is in-sync (IS) or out-of-sync (OOS) with respect to that serving cell. In LTE, RLM is carried out by the UE measuring downlink reference signals (e.g., CRS) in RRC_CONNECTED state. If RLM (i.e., by L1/PHY) indicates number of consecutive OOS conditions to the UE RRC layer, then RRC starts a radio link failure (RLF) procedure and declares RLF after expiry of a timer (e.g., T310). The L1 RLM procedure is carried out by comparing the estimated CRS measurements to some target block error rates (BLERs), called Qout and Qin. In particular, Qout and Qin correspond to BLER of hypothetical PDCCH/PCIFCH transmissions from the serving cell, with exemplary values of 10% and 2%, respectively. In NR, the network can define the RS type (e.g., CSI-RS and/or SSB), exact resources to be monitored, and even the BLER target for IS and OOS indications.

As briefly mentioned above, in addition to providing coverage via “cells,” as in LTE, NR networks also provide coverage via “beams.” In general, a DL “beam” is a coverage area of a network-transmitted RS that may be measured or monitored by a UE. Such RS can include any of the following, alone or in combination: SS/PBCH block (SSB), channel state information RS (CSI-RS), tertiary reference signals (or any other sync signal), positioning RS (PRS), demodulation RS (DMRS), phase-tracking reference signals (PTRS), etc. In general, SSB is available to all UEs regardless of RRC state, while other RS (e.g., CSI-RS, DMRS, PTRS) are associated with specific UEs that have a network connection, i.e., in RRC_CONNECTED state.

To support beam management, a UE can be configured with a CSI measurement configuration, which instructs the UE to monitor CSI-RS and to send various CSI reports to the RAN (e.g., NG-RAN). For example, the RAN indicates an explicit list of CSI resources to be monitored by the UE for each type of CSI report the UE is configured to send. Similar techniques can be used for beam management based on SSB transmitted by the network.

During preparation for handover of a UE to a target node, the source node sends the current UE configuration to the target node in the HANDOVER REQUEST message. The target node prepares a target configuration for the UE based on the current configuration and the capabilities of the target node and the UE. The target node sends the target configuration to the source node in a HANDOVER REQUEST ACKNOWLEDGE message, which the source node encapsulates in an RRCReconfiguration message to the UE. As a streamlined option, the target configuration can be signalled as a “delta-configuration” including only the differences from the UE's current configuration in the source cell.

To summarize, handover and other serving cell changes are triggered by layer 3 (L3, e.g., RRC) measurements and involves RRC signaling to change PCell and/or PSCell (e.g., when DC is configured), as well as release/add SCells (e.g., when CA is configured). Currently, L3 inter-cell mobility involves complete layer 2 (L2) and layer 1 (L1, i.e., PHY) resets, leading to longer latency, increased signaling overhead, and longer interruptions than for intra-cell beam switching.

To address these issues, NR Rel-18 includes a Work Item on NR mobility enhancements, which includes a feature referred to as L1/L2 based inter-cell mobility, L1/L2 triggered mobility (LTM), or lower layer-triggered mobility. This work item is further described in 3GPP document RP-213565. Some specific goals of this Work Item include:
Configuration and maintenance for multiple candidate cells to allow fast application of configurations for candidate cells;
Dynamic switch mechanism among candidate serving cells (including SpCell and SCell) for the potential applicable scenarios based on L1/L2 signalling;
L1 enhancements for inter-cell beam management, including L1 measurement and reporting, and beam indication;
Timing Advance management; and
CU-DU interface signaling to support L1/L2 mobility, if needed.

The proposed dynamic switch mechanism among candidate serving cells based on L1/L2 signaling is intended to reduce latency, signaling overhead, and interruptions associated with conventional L3 inter-cell mobility. According to RP-213565, LTM is applicable to at least the following scenarios or arrangements:
Standalone, CA, and NR-DC with serving cell change within one CG;
Intra-DU and intra-CU/inter-DU cell changes (applicable for standalone and CA, no new RAN interfaces are expected);
Intra-and inter-frequency cell changes;
Cell changes in frequency ranges 1 and 2 (FR1, FR2); and
Source and target cells may be synchronized or non-synchronized.

At the 3GPP RAN3 #117-e and RAN3#117bis-e meetings, there were multiple agreements made on L1/L2 based inter-cell mobility, and among these are the following:
Both intra-DU and intra-CU inter-DU scenarios are supported for L1/L2 mobility.
RAN3 will aim for a single solution for network signaling design on L1/L2 based inter-cell mobility to support all agreed scenarios. The details of solution are FFS.
gNB-CU initiates the L1/L2 mobility configuration procedure.
Configuration of candidate target cell(s) for L1/L2 mobility is initiated by the gNB-CU.
WA: RAN3 assumes that the UE sends the L1 measurement report to the gNB-DU and the gNB-DU triggers UE mobility to a target candidate cell. All details are up to RAN1 and RAN2 discussion.
During L1/L2 handover configuration, the gNB-CU sends the suggested candidate cell(s) to the gNB-DU in UE Context Modification Request procedure, FFS in one message or multiple messages.
gNB-DU may accept the target cells of L1/L2 handover and responds to the gNB-CU with the access control result in UE Context Modification Response message(s). gNB-DU may accept all or part of the target candidate cells.
gNB-DU initiated L1/L2 handover configuration is not allowed.
UE sends the lower-layer measurement report to the gNB-DU and the gNB-DU triggers UE mobility to a target candidate cell.
WA: gNB-DU indicates the gNB-CU about the UE successful access to the target cell by Access Success message.
For inter-DU inter-cell mobility, the UE Context Setup procedure is reused for handover configuration.

At the 3GPP RAN2 #119-e and RAN2 #119bis-e meetings, there were multiple agreements made on L1/L2-triggered mobility, and among these are the following:
A L1/L2 inter-cell mobility candidate (target) configuration is received within an RRC message before the L1/L2 dynamic switch is triggered.
RAN2 to use “LTM” as term for the L1/L2-triggered mobility.
Use the term “cell switch” for the procedure of triggering change of cells via the LTM feature.
Use the term “Subsequent” LTM for the case when cell switch between L1/L2 mobility candidates is done without RRC reconfiguration in between.
RAN2 assumes that sequential L1/L2 cell change between Candidates without RRC reconfiguration can be supported.
RAN2 assumes L1/L2 mobility trigger information is conveyed in a MAC CE, FFS if the MAC CE or a DCI is used for the actual triggering.
RAN2 assumes the MAC CE for L1/L2 mobility trigger contains at least a candidate configuration index.
RAN2 assumes that both RACH-based (CFRA, CBRA) and RACH-less procedures for L1/L2 mobility switch may be supported. RACH-less may be used when the UE doesn't need to acquire TA during the cell switch. RAN2 understands that the feasibility of RACH-less may depend on RAN1, and expect that RANI is working on this.
RAN2 assumes that at L1/L2 cell switch, whether the UE performs partial or full MAC reset (FFS what partial reset is, e.g., to avoid data loss), re-establishes RLC, and performs data recovery with PDCP is explicitly controlled by the network. RAN2 assumes that this can be configured by RRC. FFS if MAC CE indication(s) is/are needed.

LTM operation can be summarized as follows. A UE is pre-configured, by the network, with an RRC configuration per LTM candidate target cell. Each of these RRC configurations is also referred to as a LTM candidate target cell configuration and may be an RRCReconfiguration message or one or more IEs/fields/parameters (e.g., CellGroupConfig) that could be included in such a message. The UE performs measurements on these candidate LTM candidate target cells and transmits corresponding measurement reports to the network. The network then triggers UE execution of LTM cell switch by transmitting a lower layer message (e.g., MAC CE, DCI) to the UE, which then switches to the indicated LTM candidate target cell and connects to the cell (which then becomes the target cell).

Even so, a UE performing LTM must ensure that any LTM cell switch command is received from an authorized and/or legitimate RAN node. One approach is that each LTM candidate target cell configuration provided to the UE includes a security token, the source of which is the RAN node serving that LTM candidate target cell. The RAN node also includes the security token in any subsequent LTM cell switch command to the UE for that LTM candidate target cell. If the later security token matches the earlier security token for the same cell, the UE can assume the LTM cell switch command is valid since only a legitimate RAN node would be able to provide the correct security token.

However, an illegitimate RAN node may send a UE multiple LTM cell switch commands with random security tokens, which have some probability of matching the valid security token previously received by the UE. A probabilistic match will cause the UE to perform the LTM cell switch procedure to the cell served by a legitimate RAN node (i.e., that earlier provided the configuration), even though that node did send the command. This can cause various problems, issues, and/or difficulties, such as overload conditions in cells and failed LTM operations by UEs.

Embodiments of the present disclosure address these and other problems, difficulties, and/or issues by providing flexible and efficient techniques for the case where a UE receives an LTM cell switch command that includes a security token that does not match the security token received earlier with the corresponding LTM candidate target cell configuration. In some embodiments, the UE can invalidate the LTM cell switch command and abort the LTM cell switch procedure. These embodiments can ensure that an illegitimate RAN node will only get one chance to “guess” the correct security token associated with an LTM candidate target cell for a UE. In other embodiments, the UE can report to a legitimate RAN node (e.g., current serving RAN node) that it received an LTM cell switch command with a non-matching security token. These embodiments enable the network to take actions against potential future LTM triggers from illegitimate RAN nodes.

Embodiments can provide various benefits and/or advantages. For example, embodiments can prevent an illegitimate node from success through repeated attempts to “guess” a security token associated with an LTM cell switch command for a UE. As another example, embodiments can prevent a UE from responding to a correct “guess” after repeated attempts. In this manner, embodiments can facilitate predictable UE behavior in LTM execution and prevent overload conditions in cells served by legitimate RAN nodes due to actions by illegitimate RAN nodes.

In the present disclosure, the following terms may be used interchangeably: “L1/L2 based inter-cell mobility” (as used in the 3GPP Work Item), “L1/L2-triggered mobility”, “LTM”, “L1/L2 mobility,” “L1-mobility,” “L1 based mobility,” “L1/L2-centric inter-cell mobility,” “L1/L2 inter-cell mobility,” “inter-cell beam management,” and “inter-DU L1/L2 based inter-cell mobility”. These terms refer to a scenario in which a UE receives lower layer (i.e., below RRC, such as MAC or PHY) signaling from a network indicating for the UE to change of its serving cell (e.g., PCell) from a source cell to a target cell. Exemplary lower layer signaling includes L1 DL control information (DCI) and L2 MAC control element (CE). Compared to conventional RRC signaling, lower layer signaling reduces processing time and interruption time during mobility and may also increase mobility robustness since the network can respond more quickly to changes in the UE's channel conditions.

In the present disclosure, the term “LTM candidate target cell” refers to a non-serving cell configured for a UE, to which the UE can perform an L1/L2 inter-cell mobility operation upon reception of lower layer signaling instructing the UE to do so. The terms “candidate cell,” “candidate,” “LTM candidate”, “LTM candidate cell”, “mobility candidate,” “non-serving cell,” and “additional cell” may be used interchangeably with “LTM candidate target cell.” The UE may perform and/or report measurements (e.g., CSI measurements) on such a cell so that the network may make an informed decision about which beam (e.g., TCI state) and/or cell the UE is to be switched to by LTM execution. An LTM candidate target cell may be a primary cell candidate (e.g., for PCell or PSCell) or an SCell candidate (e.g., MCG SCell).

In the present disclosure, the term “LTM cell switch procedure” refers to the process of a UE changing its cell from a source cell to an LTM candidate target cell using L1/L2-triggered mobility. Moreover, “LTM cell switch procedure” may also be referred to as “dynamic switch”, “LTM switch”, “(LTM) cell switch”, “(LTM) serving cell change”, or “(LTM) cell change”. In this context, changing a cell may include a change in the SpCell (e.g., PCell or PSCell) and a change in SCells of a cell group (e.g., addition, modification, release, etc. of one or more SCells).

In the present disclosure, the term “configuration” when used in the context of an “LTM candidate target cell” (or equivalent term) refers to a configuration that enables a UE to access, connect, and/or operate in such a cell and is provided to the UE in advance of LTM execution. The configuration may be an RRC message or one or more portions thereof (e.g., SpCellConfig IE, SCellConfig IE, etc.). Such a configuration (including content, structure, and/or format) may also be referred to as an “RRC model”. A UE may be provided with multiple target candidate configurations, each associated with a different LTM candidate target cell. For example, a DU serving a candidate target cell generates a configuration for each cell and sends them to the CU, which provides them to the UE.

In the present disclosure, the term “lower layer protocol” refers to a protocol layer in radio air interface protocol stack that is lower than (or below) the RRC layer, protocol, such as MAC or PHY. Likewise, the term “lower layer message” refers to a message of a lower layer protocol, such as MAC Control Element (CE) or PHY downlink control information (DCI). In the specific context of LTM, such a lower layer message may be referred to as a “cell switch command” or an “LTM cell switch command”.

In the present disclosure, the terms “token”, “security token”, and “security-related token” are used interchangeably. Likewise, the terms “illegitimate RAN node” and “false base station” may be used interchangeably.

In various embodiments, a UE that is capable of LTM receives one or more LTM candidate target cell configurations from a first RAN node. The UE also receives security-related tokens associated with the respective LTM candidate target cells (and/or with the configurations). In some variants, multiple ones of the LTM candidate target cell configurations may have a common token (e.g., a token for all configurations received together). In other variants, each LTM candidate target cell configuration includes a token that is independent of tokens of other LTM candidate target cell configurations. In any case, the tokens may be included in (or received together with) the respective LTM candidate target cell configurations.

Subsequently, the UE receives from a second RAN node an LTM cell switch command corresponding to one of the configured LTM candidate target cells. The LTM cell switch command includes a token. The UE compares the token received in the LTM cell switch command and the token in the corresponding LTM candidate target cell configuration. When the two tokens match, the UE executes the LTM cell switch procedure according to the command. When there is a mismatch between the two tokens (i.e., the two security tokens are not identical and/or do not correspond to each other in some required manner), the UE can take one or more actions according to various embodiments.

In some embodiments, when the UE detects a mismatch between a token received in the LTM cell switch command and a token in a corresponding LTM candidate target cell configuration, the UE determines that the LTM cell switch command is invalid and aborts the LTM cell switch procedure associated with the command. By doing this, the UE prevents an illegitimate RAN node that is trying to trigger an LTM cell switch procedure to succeed by repeated attempts using different tokens.

In various embodiments, the UE determines that a received LTM cell switch command is invalid when one of the following criteria are met:
detecting a single mismatch between a token received in the LTM cell switch command and a token in a corresponding LTM candidate target cell configuration;
detecting N>1 mismatches between a token received in the LTM cell switch command and a token in a corresponding LTM candidate target cell configuration, with N being fixed (e.g., from specification) or network-configured; and
receiving an indication from a RAN node that the LTM cell switch procedure was invalid, illegitimate, and/or unintended.

In some embodiments, the UE can perform one or more of the following in response to determining that an LTM cell switch command is invalid:
refrain from initiating an LTM cell switch procedure to the candidate target cell, even in response to receiving a subsequent LTM cell switch command to the same candidate target cell with a valid or matching token;
discard the LTM cell switch command and maintain a connection with the UE's current serving cell and serving RAN node; and
discard the LTM cell switch command and release all LTM candidate target cells that were configured by the RAN node from which an invalid or mismatched token was received. If the RAN node that configured the LTM candidate target cell is different than the RAN node that sent the LTM cell switch command with an invalid or mismatched token, the UE releases the LTM candidate target cells configured by both networks nodes.

In some embodiments, the UE can determine that one or more subsequently received LTM cell switch commands are invalid based on the initial LTM cell switch command determined to be invalid based on the non-matching token, regardless of whether the subsequent LTM cell switch commands include tokens that match the tokens in the configurations for the respective cells. In other words, the invalidity of the subsequent LTM cell switch commands is implied by the determined invalidity of the initial LTM switch cell command. This implication can be for all subsequent LTM switch cell commands, for some time period, only subsequent LTM switch cell commands received from the RAN node that sent the initial LTM switch cell command, etc.

In some embodiments, when the UE detects a mismatch between a token received in the LTM cell switch command and a token in a corresponding LTM candidate target cell configuration, the UE sends a report about this detection to its current serving RAN node. In various embodiments, the report sent by the UE may include one or more of the following:
an identifier of the LTM cell switch command that included the non-matching token (e.g. an index or code associated with the LTM cell switch command);
an identifier of the LTM candidate target cell associated with the LTM cell switch command;
the non-matching token received with the command; and
the reference token in the corresponding LTM candidate target cell configuration.

In some embodiments, the UE sends the report via RRC, e.g., within a new or an existing RRC message. One benefit of using RRC for this report is that RRC communication is protected for both integrity and confidentiality (e.g., via ciphering). In other embodiments, the UE will send the report via MAC CE, DCI, or another lower layer signaling (e.g., below RRC).

In some embodiments, upon receiving such a report from the UE, the network may perform one or more of the following actions:
Send the UE another LTM cell switch command to trigger an LTM cell switch to the same LTM candidate target cell (e.g., associated with the initial command) or to a different LTM candidate target cell. The new LTM cell switch command may have a different token than the old LTM command.
Send the UE one or more new tokens to be used with an existing LTM candidate target cell configuration. In some variants, the new tokens may have a different format (e.g., greater length) that makes them more difficult for an illegitimate RAN node to guess through repeated attempts (i.e., lower match probability).
Send the UE an indication to release all the LTM candidate target cells configured by any RAN node. In this case, the serving RAN node may decide to inform other RAN nodes (e.g., that configured other LTM candidate target cells for the UE) that the UE has released all of its configured LTM candidate target cells.
Send an indication to another network node or function (NNF, e.g., CU, RAN node, CN node, OAM) to inform that an illegitimate RAN node has been detected. In this case, one or more of the following information may be included in or with the indication:
an identifier of the LTM cell switch command that included the non-matching token (e.g. an index or code associated with the LTM cell switch command);
an identifier of the LTM candidate target cell associated with the LTM cell switch command;
the non-matching token received with the command;
the reference token in the corresponding LTM candidate target cell configuration; and
an identifier of the RAN node that provided the non-matching token (and believed to be illegitimate).

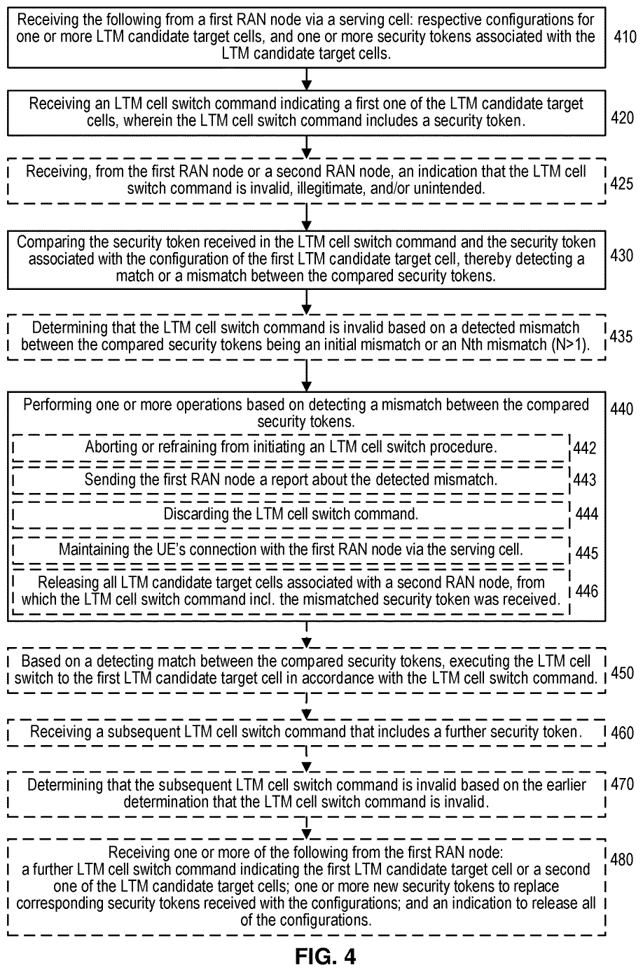

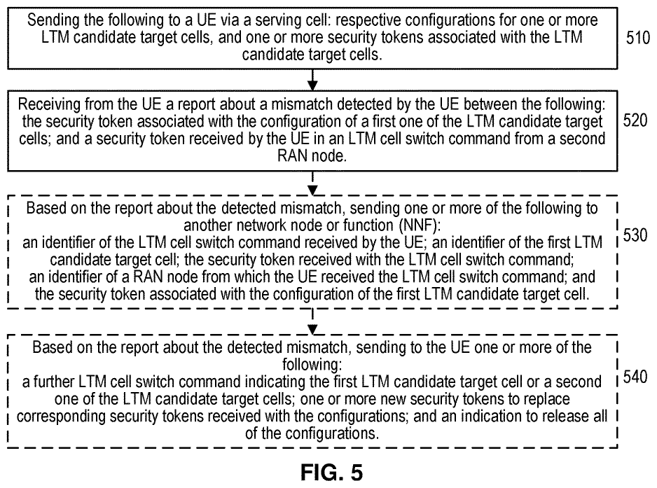

Various features of the embodiments described above correspond to various operations illustrated in FIGS. 4-5, which show exemplary methods (e.g., procedures) for a UE and a RAN node, respectively. In other words, various features of the operations described below correspond to various embodiments described above. Furthermore, the exemplary methods shown in FIGS. 4-5 can be used cooperatively to provide various benefits, advantages, and/or solutions to problems described herein. Although FIGS. 4-5 show specific blocks in particular orders, the operations of the exemplary methods can be performed in different orders than shown and can be combined and/or divided into blocks having different functionality than shown. Optional blocks or operations are indicated by dashed lines.

In particular, FIG. 4 shows an exemplary method (e.g., procedure) for a UE configured for L1/L2-triggered mobility (LTM) in a RAN, according to various embodiments of the present disclosure. The exemplary method can be performed by a UE (e.g., wireless device, etc.) such as described elsewhere herein.

The exemplary method includes the operations of block 410, where the UE receives the following from a first RAN node via a serving cell: respective configurations for one or more LTM candidate target cells, and one or more security tokens associated with the LTM candidate target cells. The exemplary method also includes the operations of block 420, where the UE receives an LTM cell switch command indicating a first one of the LTM candidate target cells. The LTM cell switch command includes a security token. The exemplary method also includes the operations of block 430, where the UE compares the security token received in the LTM cell switch command and the security token associated with the configuration of the first LTM candidate target cell, thereby detecting a match or a mismatch between the compared security tokens. The exemplary method also includes the operations of block 440, where the UE performs one or more of the following operations (labelled with corresponding sub-block numbers) based on detecting mismatch between the compared security tokens (e.g., in block 430):
(442) aborting or refraining from initiating the LTM cell switch procedure to the first LTM candidate cell, and
(443) sending the first RAN node a report about the detected mismatch between the compared security tokens.

In some embodiments, each configuration includes an associated security token, which is independent of the security tokens of other configurations. In other embodiments, at least two of the configurations are associated with a common security token, which is received together with the at least two configurations.

In some embodiments, the exemplary method also includes the operations of block 435, where the UE determines that the LTM cell switch command is invalid based on a detected mismatch between the compared security tokens (e.g., in block 430) being one of the following:
an initial mismatch detected based on comparing security tokens; or
an Nth mismatch detected based on comparing security tokens, where N>1.

In some of these embodiments, determining that the LTM cell switch command is invalid in block 435 is further based on the operations of block 425, where the UE receives, from the first RAN node or a second RAN node, an indication that the LTM cell switch command indicating the first LTM candidate target cell is invalid, illegitimate, and/or unintended.

In some of these embodiments, the exemplary method also includes the operations of block 460, where after determining that the LTM cell switch command is invalid (e.g., in block 435), the UE receives a subsequent LTM cell switch command that includes a further security token. In such embodiments, the exemplary method also includes the operations of block 470, where the UE determines that the subsequent LTM cell switch command is invalid based on the earlier determination that the LTM cell switch command is invalid (e.g., in block 435).

In some of these embodiments, the subsequent LTM cell switch command indicates the first LTM candidate target cell and determining that the subsequent LTM cell switch command is invalid in block 470 is independent of whether the further security token matches the security token associated with the configuration of the first LTM candidate target cell.

In other of these embodiments, the subsequent LTM cell switch command indicates a second one of the LTM candidate target cells and is received from a same RAN node as the LTM cell switch command. In such embodiments, determining that the subsequent LTM cell switch command is invalid in block 470 is independent of whether the further security token matches the security token associated with the configuration of the second LTM candidate target cell.

In some embodiments, the one or more operations performed in block 440 based on detecting a mismatch between the compared security tokens also include one or more of the following, labelled with corresponding sub-block numbers:
(444) discarding the LTM cell switch command;
(445) maintaining the UE's connection with the first RAN node via the serving cell; and
(446) releasing all LTM candidate target cells associated with a third RAN node, from which the LTM cell switch command including the mismatched security token was received.

In some embodiments, the report about the detected mismatch between the compared security tokens includes one or more of the following:
an identifier of the LTM cell switch command;
an identifier of the first LTM candidate target cell;
the security token received with the LTM cell switch command;
an identifier of a RAN node from which the UE received the LTM cell switch command; and
the security token associated with the configuration of the first LTM candidate target cell.

In some embodiments, the exemplary method also includes the operations of block 480, where after sending the report, the UE receives one or more of the following from the first RAN node:
a further LTM cell switch command indicating the first LTM candidate target cell or a second one of the LTM candidate target cells;
one or more new security tokens to replace corresponding security tokens received with the configurations; and
an indication to release all of the configurations.

In some of these embodiments, the one or more new security tokens have greater lengths or sizes than the corresponding security tokens being replaced.

In some embodiments, the exemplary method also includes the operations of block 450, where based on detecting a match between the compared security tokens (e.g., in block 430), the UE can execute the LTM cell switch to the first LTM candidate target cell in accordance with the command.

In some embodiments, each of the LTM candidate target cells is a candidate to be used by the UE as one of the following: special cell (SpCell), primary cell (PCell), primary secondary cell group cell (PSCell), and secondary cell (SCell).

In addition, FIG. 5 shows an exemplary method (e.g., procedure) for a RAN node configured to support L1/L2-triggered mobility (LTM) of UEs in the RAN, according to various embodiments of the present disclosure. The exemplary method can be performed by a RAN node (e.g., base stations, eNBs, gNBs, ng-eNBs, DUs, TRPs, etc.) such as described elsewhere herein.

The exemplary method includes the operations of block 510, where the RAN node sends the following to a UE via a serving cell: respective configurations for one or more LTM candidate target cells, and one or more security tokens associated with the LTM candidate target cells. The exemplary method also includes the operations of block 520, where the RAN node subsequently receives from the UE a report about a mismatch detected by the UE between the following: the security token associated with the configuration of a first one of the LTM candidate target cells, and a security token received by the UE in an LTM cell switch command from a second RAN node.

In some embodiments, each configuration includes an associated security token, which is independent of the security tokens of other configurations. In other embodiments, at least two of the configurations are associated with a common security token, which is sent together with the at least two configurations.

In some embodiments, the detected mismatch indicated by the report is one of the following:
an initial mismatch detected by the UE based on comparing security tokens; or
an Nth mismatch detected by the UE based on comparing security tokens, where N>1.

In some embodiments, the report about the detected mismatch between the compared security tokens includes one or more of the following:
an identifier of the LTM cell switch command received by the UE;
an identifier of the first LTM candidate target cell;
the security token received with the LTM cell switch command;
an identifier of a RAN node from which the UE received the LTM cell switch command; and
the security token associated with the configuration of the first LTM candidate target cell.

In some embodiments, the exemplary method can also include the operations of block 540, where based on the report about the detected mismatch, the RAN node sends to the UE one or more of the following:
a further LTM cell switch command indicating the first LTM candidate target cell or a second one of the LTM candidate target cells;
one or more new security tokens to replace corresponding security tokens received with the configurations; and
an indication to release all of the configurations.
   In some of these embodiments, the one or more new security tokens have greater lengths or sizes than the corresponding security tokens being replaced.

In some embodiments, the exemplary method also includes the operations of block 530, where based on the report about the detected mismatch, the RAN node sends one or more of the following to another network node or function (NNF):
an identifier of the LTM cell switch command received by the UE;
an identifier of the first LTM candidate target cell;
the security token received with the LTM cell switch command;
an identifier of a RAN node from which the UE received the LTM cell switch command; and
the security token associated with the configuration of the first LTM candidate target cell.

In some embodiments, the other NNF is one of the following: a CU associated with the RAN node; an NNF in a core network coupled to the RAN; or an operations/administration/maintenance (OAM) system coupled to the RAN.

In some embodiments, each of the LTM candidate target cells is a candidate to be used by the UE as one of the following: SpCell, PCell, PSCell, and SCell.

Although various embodiments are described above in terms of methods, techniques, and/or procedures, the person of ordinary skill will readily comprehend that such methods, techniques, and/or procedures can be embodied by various combinations of hardware and software in various systems, communication devices, computing devices, control devices, apparatuses, non-transitory computer-readable media, computer program products, etc.

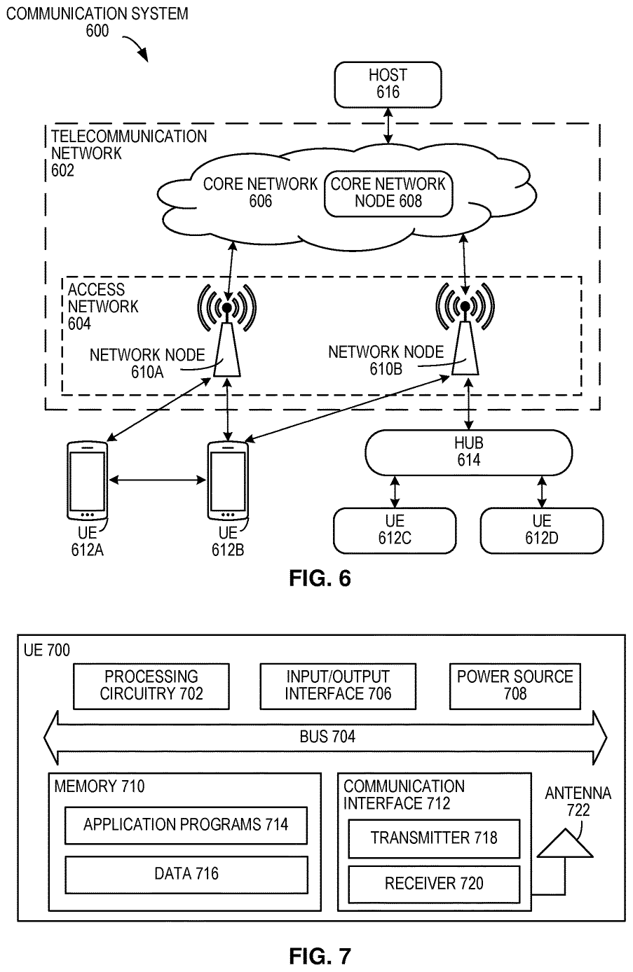

FIG. 6 shows an example of a communication system 600 in accordance with some embodiments. In this example, communication system 600 includes a telecommunication network 602 that includes an access network 604 (e.g., RAN) and a core network 606, which includes one or more core network nodes 608. Access network 604 includes one or more access network nodes, such as network nodes 610a-b (one or more of which may be generally referred to as network nodes 610), or any other similar 3GPP access node or non-3GPP access point. Network nodes 610 facilitate direct or indirect connection of UEs, such as by connecting UEs 612a-d (one or more of which may be generally referred to as UEs 612) to core network 606 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, communication system 600 may include any number of wired or wireless networks, network nodes, UEs, and/or any other components or systems that may facilitate or participate in the communication of data and/or signals whether via wired or wireless connections. Communication system 600 may include and/or interface with any type of communication, telecommunication, data, cellular, radio network, and/or other similar type of system.

UEs 612 may be any of a wide variety of communication devices, including wireless devices arranged, configured, and/or operable to communicate wirelessly with network nodes 610 and other communication devices. Similarly, network nodes 610 are arranged, capable, configured, and/or operable to communicate directly or indirectly with UEs 612 and/or with other network nodes or equipment in telecommunication network 602 to enable and/or provide network access, such as wireless network access, and/or to perform other functions, such as administration in telecommunication network 602.

In the depicted example, core network 606 connects network nodes 610 to one or more hosts, such as host 616. These connections may be direct or indirect via one or more intermediary networks or devices. In other examples, network nodes may be directly coupled to hosts. Core network 606 includes one or more core network nodes (e.g., 608) that are structured with hardware and software components. Features of these components may be substantially similar to those described with respect to the UEs, network nodes, and/or hosts, such that the descriptions thereof are generally applicable to the corresponding components of core network node 608. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

Host 616 may be under the ownership or control of a service provider other than an operator or provider of access network 604 and/or telecommunication network 602, and may be operated by the service provider or on behalf of the service provider. Host 616 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, communication system 600 of FIG. 6 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, telecommunication network 602 is a cellular network that implements 3GPP standardized features. Accordingly, telecommunication network 602 may support network slicing to provide different logical networks to different devices that are connected to telecommunication network 602. For example, telecommunication network 602 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, UEs 612 are configured to transmit and/or receive information without direct human interaction. For instance, a UE may be designed to transmit information to access network 604 on a predetermined schedule, when triggered by an internal or external event, or in response to requests from access network 604. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio—Dual Connectivity (EN-DC).

In the example, hub 614 communicates with access network 604 to facilitate indirect communication between one or more UEs (e.g., 612c and/or 612d) and network nodes (e.g., 610b). In some examples, hub 614 may be a controller, router, content source and analytics, or any of the other communication devices described herein regarding UEs. For example, hub 614 may be a broadband router enabling access to core network 606 for the UEs. As another example, hub 614 may be a controller that sends commands or instructions to one or more actuators in the UEs. Commands or instructions may be received from the UEs, network nodes 610, or by executable code, script, process, or other instructions in hub 614. As another example, hub 614 may be a data collector that acts as temporary storage for UE data and, in some embodiments, may perform analysis or other processing of the data. As another example, hub 614 may be a content source. For example, for a UE that is a VR headset, display, loudspeaker or other media delivery device, hub 614 may retrieve VR assets, video, audio, or other media or data related to sensory information via a network node, which hub 614 then provides to the UE either directly, after performing local processing, and/or after adding additional local content. In still another example, hub 614 acts as a proxy server or orchestrator for the UEs, in particular in if one or more of the UEs are low energy IoT devices.

Hub 614 may have a constant/persistent or intermittent connection to network node 610b. Hub 614 may also allow for a different communication scheme and/or schedule between hub 614 and UEs (e.g., 612c and/or 612d), and between hub 614 and core network 606. In other examples, hub 614 is connected to core network 606 and/or one or more UEs via a wired connection. Moreover, hub 614 may be configured to connect to an M2M service provider over access network 604 and/or to another UE over a direct connection. In some scenarios, UEs may establish a wireless connection with network nodes 610 while still connected via hub 614 via a wired or wireless connection. In some embodiments, hub 614 may be a dedicated hub—that is, a hub whose primary function is to route communications to/from the UEs from/to network node 610b. In other embodiments, hub 614 may be a non-dedicated hub—that is, a device which can route communications between the UEs and network node 610b, but which is additionally capable of operating as a communication start and/or end point for certain data channels.

FIG. 7 shows a UE 700 in accordance with some embodiments. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by 3GPP, including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

UE 700 includes processing circuitry 702 that is operatively coupled via bus 704 to input/output interface 706, power source 708, memory 710, communication interface 712, and possibly one or more other components not explicitly shown. Certain UEs may utilize all or a subset of the components shown in FIG. 7. The level of integration between the components may vary from one UE to another UE. Further, certain UEs may contain multiple instances of a component, such as multiple processors, memories, transceivers, transmitters, receivers, etc.

Processing circuitry 702 is configured to process instructions and data and may be configured to implement any sequential state machine operative to execute instructions stored as machine-readable computer programs in memory 710. Processing circuitry 702 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, processing circuitry 702 may include multiple central processing units (CPUs).

In the example, input/output interface 706 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into UE 700. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, power source 708 is structured as a battery or battery pack. Other types of power sources, such as an external power source (e.g., an electricity outlet), photovoltaic device, or power cell, may be used. Power source 708 may further include power circuitry for delivering power from power source 708 itself, and/or an external power source, to the various parts of UE 700 via input circuitry or an interface such as an electrical power cable. Delivering power may be, for example, for charging of power source 708. Power circuitry may perform any formatting, converting, or other modification to the power from power source 708 to make the power suitable for the respective components of UE 700 to which power is supplied.

Memory 710 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, memory 710 includes one or more application programs 714, such as an operating system, web browser application, a widget, gadget engine, or other application, and corresponding data 716. Memory 710 may store, for use by UE 700, any of a variety of various operating systems or combinations of operating systems.

Memory 710 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ Memory 710 may allow UE 700 to access instructions, application programs and the like, stored on transitory or non-transitory memory media, to off-load data, or to upload data. An article of manufacture, such as one utilizing a communication system may be tangibly embodied as or in memory 710, which may be or comprise a device-readable storage medium.

Processing circuitry 702 may be configured to communicate with an access network or other network using communication interface 712. Communication interface 712 may comprise one or more communication subsystems and may include or be communicatively coupled to an antenna 722. Communication interface 712 may include one or more transceivers used to communicate, such as by communicating with one or more remote transceivers of another device capable of wireless communication (e.g., another UE or a network node in an access network). Each transceiver may include transmitter 718 and/or receiver 720 appropriate to provide network communications (e.g., optical, electrical, frequency allocations, and so forth). Moreover, transmitter 718 and/or receiver 720 may be coupled to one or more antennas (e.g., 722) and may share circuit components, software or firmware, or alternatively be implemented separately.

In the illustrated embodiment, communication functions of communication interface 712 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 712, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., an alert is sent when moisture is detected), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to UE 700 shown in FIG. 7.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IOT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

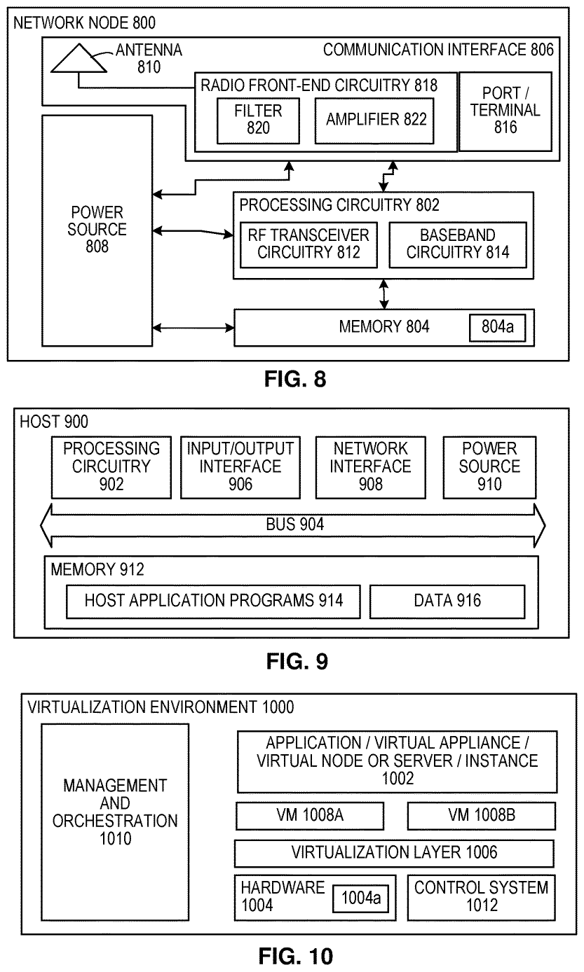

FIG. 8 shows a network node 800 in accordance with some embodiments. Examples of network nodes include, but are not limited to, access points (e.g., radio access points) and base stations (e.g., radio base stations, Node Bs, eNBs, and gNBs).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

Network node 800 includes processing circuitry 802, memory 804, communication interface 806, and power source 808. Network node 800 may be composed of multiple physically separate components (e.g., a NodeB component and a RNC component, or a BTS component and a BSC component, etc.), which may each have their own respective components. In certain scenarios in which network node 800 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, network node 800 may be configured to support multiple radio access technologies (RATs). In such embodiments, some components may be duplicated (e.g., separate memory 804 for different RATs) and some components may be reused (e.g., an antenna may be shared by different RATs). Network node 800 may also include multiple sets of the various illustrated components for different wireless technologies integrated into network node 800, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 800.

Processing circuitry 802 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 800 components, such as memory 804, to provide network node 800 functionality.

In some embodiments, processing circuitry 802 includes a system on a chip (SOC). In some embodiments, processing circuitry 802 includes one or more of radio frequency (RF) transceiver circuitry 812 and baseband processing circuitry 814. In some embodiments, RF transceiver circuitry 812 and baseband processing circuitry 814 may be on separate chips (or sets of chips), boards, or units, such as radio units and digital units. In alternative embodiments, part or all of RF transceiver circuitry 812 and baseband processing circuitry 814 may be on the same chip or set of chips, boards, or units.

Memory 804 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by processing circuitry 802. Memory 804 may store any suitable instructions, data, or information, including a computer program, software, an application including one or more of logic, rules, code, tables, and/or other instructions (collectively denoted computer program 804a, which may be in the form of a computer program product) capable of being executed by processing circuitry 802 and utilized by network node 800. Memory 804 may be used to store any calculations made by processing circuitry 802 and/or any data received via communication interface 806. In some embodiments, processing circuitry 802 and memory 804 is integrated.

Communication interface 806 is used in wired or wireless communication of signaling and/or data between a network node, access network, and/or UE. As illustrated, communication interface 806 comprises port(s)/terminal(s) 816 to send and receive data, for example to and from a network over a wired connection. Communication interface 806 also includes radio front-end circuitry 818 that may be coupled to, or in certain embodiments a part of, antenna 810. Radio front-end circuitry 818 comprises filters 820 and amplifiers 822. Radio front-end circuitry 818 may be connected to an antenna 810 and processing circuitry 802. The radio front-end circuitry may be configured to condition signals communicated between antenna 810 and processing circuitry 802. Radio front-end circuitry 818 may receive digital data that is to be sent out to other network nodes or UEs via a wireless connection. Radio front-end circuitry 818 may convert the digital data into a radio signal having the appropriate channel and bandwidth parameters using a combination of filters 820 and/or amplifiers 822. The radio signal may then be transmitted via antenna 810. Similarly, when receiving data, antenna 810 may collect radio signals which are then converted into digital data by radio front-end circuitry 818. The digital data may be passed to processing circuitry 802. In other embodiments, the communication interface may comprise different components and/or different combinations of components.

In certain alternative embodiments, network node 800 does not include separate radio front-end circuitry 818, instead, processing circuitry 802 includes radio front-end circuitry and is connected to antenna 810. Similarly, in some embodiments, all or some of the RF transceiver circuitry 812 is part of communication interface 806. In still other embodiments, communication interface 806 includes one or more ports or terminals 816, radio front-end circuitry 818, and the RF transceiver circuitry 812, as part of a radio unit (not shown), and communication interface 806 communicates with the baseband processing circuitry 814, which is part of a digital unit (not shown).

Antenna 810 may include one or more antennas, or antenna arrays, configured to send and/or receive wireless signals. Antenna 810 may be coupled to radio front-end circuitry 818 and may be any type of antenna capable of transmitting and receiving data and/or signals wirelessly. In certain embodiments, antenna 810 is separate from network node 800 and connectable to network node 800 through an interface or port.

Antenna 810, communication interface 806, and/or processing circuitry 802 may be configured to perform any receiving operations and/or certain obtaining operations described herein as being performed by the network node. Any information, data and/or signals may be received from a UE, another network node and/or any other network equipment. Similarly, antenna 810, communication interface 806, and/or processing circuitry 802 may be configured to perform any transmitting operations described herein as being performed by the network node. Any information, data and/or signals may be transmitted to a UE, another network node and/or any other network equipment.

Power source 808 provides power to the various components of network node 800 in a form suitable for the respective components (e.g., at a voltage and current level needed for each respective component). Power source 808 may further comprise, or be coupled to, power management circuitry to supply the components of network node 800 with power for performing the functionality described herein. For example, network node 800 may be connectable to an external power source (e.g., the power grid, an electricity outlet) via an input circuitry or interface such as an electrical cable, whereby the external power source supplies power to power circuitry of power source 808. As a further example, power source 808 may comprise a source of power in the form of a battery or battery pack which is connected to, or integrated in, power circuitry. The battery may provide backup power should the external power source fail.

Embodiments of network node 800 may include additional components beyond those shown in FIG. 8 for providing certain aspects of the network node's functionality, including any of the functionality described herein and/or any functionality necessary to support the subject matter described herein. For example, network node 800 may include user interface equipment to allow input of information into network node 800 and to allow output of information from network node 800. This may allow a user to perform diagnostic, maintenance, repair, and other administrative functions for network node 800.

FIG. 9 is a block diagram of a host 900, which may be an embodiment of host 616 of FIG. 6, in accordance with various aspects described herein. Host 900 may be or comprise various combinations hardware and/or software, including a standalone server, a blade server, a cloud-implemented server, a distributed server, a virtual machine, container, or processing resources in a server farm. Host 900 may provide one or more services to one or more UEs.

Host 900 includes processing circuitry 902 that is operatively coupled via bus 904 to input/output interface 906, network interface 908, power source 910, and memory 912. Other components may be included in other embodiments. Features of these components may be substantially similar to those described with respect to the devices of previous figures, such as FIGS. 7 and 8, such that the descriptions thereof are generally applicable to the corresponding components of host 900.

Memory 912 may include one or more computer programs including one or more host application programs 914 and data 916, which may include user data, e.g., data generated by a UE for host 900 or data generated by host 900 for a UE. Embodiments of host 900 may utilize only a subset or all of the components shown. Host application programs 914 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). Host application programs 914 may also provide for user authentication and licensing checks and may periodically report health, routes, and content availability to a central node, such as a device in or on the edge of a core network. Accordingly, host 900 may select and/or indicate a different host for over-the-top services for a UE. Host application programs 914 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 10 is a block diagram illustrating a virtualization environment 1000 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) 1008 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1002 (which may alternatively be called software instances, virtual appliances, network functions, virtual nodes, virtual network functions, etc.) are run in virtualization environment 1000 to implement some of the features, functions, and/or benefits of some of the embodiments disclosed herein.

Hardware 1004 includes processing circuitry, memory that stores software and/or instructions (collectively denoted computer program 1004a, which may be in the form of a computer program product) executable by hardware processing circuitry, and/or other hardware devices as described herein, such as a network interface, input/output interface, and so forth. Software may be executed by the processing circuitry to instantiate one or more virtualization layers 1006 (also referred to as hypervisors or virtual machine monitors (VMMs)), provide VMs 1008a-b (one or more of which may be generally referred to as VMs 1008), and/or perform any of the functions, features and/or benefits described in relation with some embodiments described herein. Virtualization layer 1006 may present a virtual operating platform that appears like networking hardware to VMs 1008.

VMs 1008 comprise virtual processing, virtual memory, virtual networking or interface and virtual storage, and may be run by a corresponding virtualization layer 1006. Different embodiments of the instance of a virtual appliance 1002 may be implemented on one or more of VMs 1008, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, each VM 1008 may be a software implementation of a physical machine that runs programs as if they were executing on a physical, non-virtualized machine. Each VM 1008, and that part of hardware 1004 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1008 on top of hardware 1004 and corresponds to application 1002.

Hardware 1004 may be implemented in a standalone network node with generic or specific components. Hardware 1004 may implement some functions via virtualization. Alternatively, hardware 1004 may be part of a larger cluster of hardware (e.g. such as in a data center or CPE) where many hardware nodes work together and are managed via management and orchestration 1010, which, among others, oversees lifecycle management of applications 1002. In some embodiments, hardware 1004 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1012 which may alternatively be used for communication between hardware nodes and radio units.

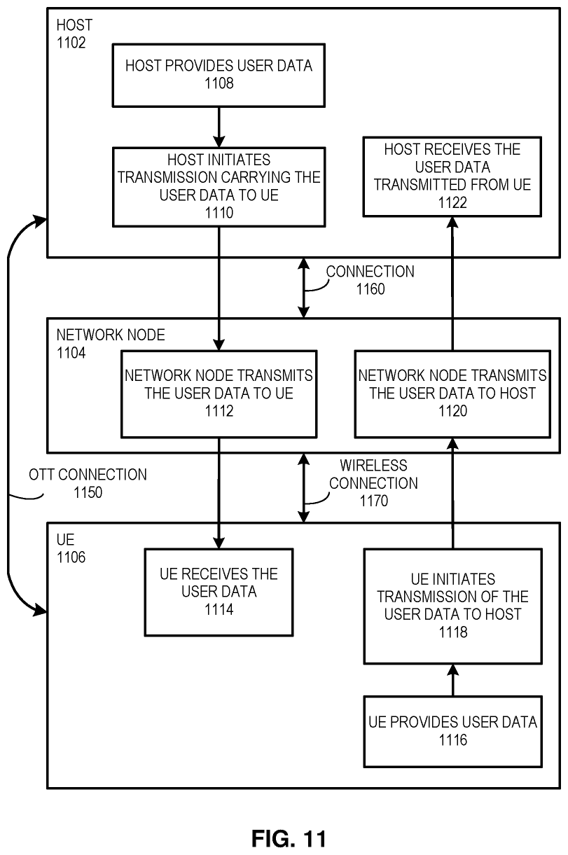

FIG. 11 shows a communication diagram of a host 1102 communicating via a network node 1104 with a UE 1106 over a partially wireless connection in accordance with some embodiments. Example implementations, in accordance with various embodiments, of the UE (such as a UE 612a of FIG. 6 and/or UE 700 of FIG. 7), network node (such as network node 610a of FIG. 6 and/or network node 800 of FIG. 8), and host (such as host 616 of FIG. 6 and/or host 900 of FIG. 9) discussed in the preceding paragraphs will now be described with reference to FIG. 11.

Like host 900, embodiments of host 1102 include hardware, such as a communication interface, processing circuitry, and memory. Host 1102 also includes software, which is stored in or accessible by host 1102 and executable by the processing circuitry. The software includes a host application that may be operable to provide a service to a remote user, such as UE 1106 connecting via an over-the-top (OTT) connection 1150 extending between UE 1106 and host 1102. In providing the service to the remote user, a host application may provide user data which is transmitted using OTT connection 1150.

Network node 1104 includes hardware enabling it to communicate with host 1102 and UE 1106. Connection 1160 may be direct or pass through a core network (like core network 606 of FIG. 6) and/or one or more other intermediate networks, such as one or more public, private, or hosted networks. For example, an intermediate network may be a backbone network or the Internet.

UE 1106 includes hardware and software, which is stored in or accessible by UE 1106 and executable by the UE's processing circuitry. The software includes a client application, such as a web browser or operator-specific “app” that may be operable to provide a service to a human or non-human user via UE 1106 with the support of host 1102. In host 1102, an executing host application may communicate with the executing client application via OTT connection 1150 terminating at UE 1106 and host 1102. In providing the service to the user, the UE's client application may receive request data from the host's host application and provide user data in response to the request data. OTT connection 1150 may transfer both the request data and the user data. The UE's client application may interact with the user to generate the user data that it provides to the host application through OTT connection 1150.

OTT connection 1150 may extend via a connection 1160 between host 1102 and network node 1104 and via a wireless connection 1170 between network node 1104 and UE 1106 to provide the connection between host 1102 and UE 1106. Connection 1160 and wireless connection 1170, over which OTT connection 1150 may be provided, have been drawn abstractly to illustrate the communication between host 1102 and UE 1106 via network node 1104, without explicit reference to any intermediary devices and the precise routing of messages via these devices.

As an example of transmitting data via OTT connection 1150, in step 1108, host 1102 provides user data, which may be performed by executing a host application. In some embodiments, the user data is associated with a particular human user interacting with UE 1106. In other embodiments, the user data is associated with a UE 1106 that shares data with host 1102 without explicit human interaction. In step 1110, host 1102 initiates a transmission carrying the user data towards UE 1106. Host 1102 may initiate the transmission responsive to a request transmitted by UE 1106. The request may be caused by human interaction with UE 1106 or by operation of the client application executing on UE 1106. The transmission may pass via network node 1104, in accordance with the teachings of the embodiments described throughout this disclosure. Accordingly, in step 1112, network node 1104 transmits to UE 1106 the user data that was carried in the transmission that host 1102 initiated, in accordance with the teachings of the embodiments described throughout this disclosure. In step 1114, UE 1106 receives the user data carried in the transmission, which may be performed by a client application executed on UE 1106 associated with the host application executed by host 1102.

In some examples, UE 1106 executes a client application which provides user data to host 1102. The user data may be provided in reaction or response to the data received from host 1102. Accordingly, in step 1116, UE 1106 may provide user data, which may be performed by executing the client application. In providing the user data, the client application may further consider user input received from the user via an input/output interface of UE 1106. Regardless of the specific manner in which the user data was provided, UE 1106 initiates, in step 1118, transmission of the user data towards host 1102 via network node 1104. In step 1120, in accordance with the teachings of the embodiments described throughout this disclosure, network node 1104 receives user data from UE 1106 and initiates transmission of the received user data towards host 1102. In step 1122, host 1102 receives the user data carried in the transmission initiated by UE 1106.

One or more of the various embodiments improve the performance of OTT services provided to UE 1106 using OTT connection 1150, in which wireless connection 1170 forms the last segment. More precisely, the teachings of these embodiments can prevent an illegitimate RAN node from success through repeated attempts to “guess” a security token associated with an LTM cell switch command for a UE. Embodiments can also prevent a UE from responding to a correct “guess” after repeated attempts. In this manner, embodiments can facilitate predictable UE behavior in LTM execution and prevent overload conditions in cells served by legitimate RAN nodes due to actions by illegitimate RAN nodes. When UEs and RAN nodes improved in this manner are used to deliver OTT services, they increase the value of the OTT services to end user(s) and service provider(s).

In an example scenario, factory status information may be collected and analyzed by host 1102. As another example, host 1102 may process audio and video data which may have been retrieved from a UE for use in creating maps. As another example, host 1102 may collect and analyze real-time data to assist in controlling vehicle congestion (e.g., controlling traffic lights). As another example, host 1102 may store surveillance video uploaded by a UE. As another example, host 1102 may store or control access to media content such as video, audio, VR or AR which it can broadcast, multicast or unicast to UEs. As other examples, host 1102 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring OTT connection 1150 between host 1102 and UE 1106, in response to variations in the measurement results. The measurement procedure and/or the network functionality for reconfiguring the OTT connection may be implemented in software and hardware of host 1102 and/or UE 1106. In some embodiments, sensors (not shown) may be deployed in or in association with other devices through which OTT connection 1150 passes; the sensors may participate in the measurement procedure by supplying values of the monitored quantities exemplified above, or supplying values of other physical quantities from which software may compute or estimate the monitored quantities. The reconfiguring of OTT connection 1150 may include message format, retransmission settings, preferred routing etc. ; the reconfiguring need not directly alter the operation of network node 1104. Such procedures and functionalities may be known and practiced in the art. In certain embodiments, measurements may involve proprietary UE signaling that facilitates measurements of throughput, propagation times, latency and the like, by host 1102. The measurements may be implemented in that software causes messages to be transmitted, in particular empty or ‘dummy’ messages, using OTT connection 1150 while monitoring propagation times, errors, etc.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures that, although not explicitly shown or described herein, embody the principles of the disclosure and can be thus within the spirit and scope of the disclosure. Various embodiments can be used together with one another, as well as interchangeably therewith, as should be understood by those having ordinary skill in the art.

The term unit, as used herein, can have conventional meaning in the field of electronics, electrical devices and/or electronic devices and can include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

As described herein, device and/or apparatus can be represented by a semiconductor chip, a chipset, or a (hardware) module comprising such chip or chipset; this, however, does not exclude the possibility that a functionality of a device or apparatus, instead of being hardware implemented, be implemented as a software module such as a computer program or a computer program product comprising executable software code portions for execution or being run on a processor. Furthermore, functionality of a device or apparatus can be implemented by any combination of hardware and software. A device or apparatus can also be regarded as an assembly of multiple devices and/or apparatuses, whether functionally in cooperation with or independently of each other. Moreover, devices and apparatuses can be implemented in a distributed fashion throughout a system, so long as the functionality of the device or apparatus is preserved. Such and similar principles are considered as known to a skilled person.

Furthermore, functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

In addition, certain terms used in the present disclosure, including the specification, drawings and embodiments thereof, can be used synonymously in certain instances, including, but not limited to, e.g., data and information. It should be understood that, while these words and/or other words that can be synonymous to one another, can be used synonymously herein, that there can be instances when such words can be intended to not be used synonymously. Further, to the extent that the prior art knowledge has not been explicitly incorporated by reference herein above, it is explicitly incorporated herein in its entirety. All publications referenced are incorporated herein by reference in their entireties.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

In addition, certain terms used in the present disclosure, including the specification and drawings, can be used synonymously in certain instances (e.g., “data” and “information”). It should be understood, that although these terms (and/or other terms that can be synonymous to one another) can be used synonymously herein, there can be instances when such words can be intended to not be used synonymously.

The techniques and apparatus described herein include, but are not limited to, the following enumerated examples:

A1. A method for a user equipment (UE) configured for L1/L2-triggered mobility (LTM) in a radio access network (RAN), the method comprising:
receiving the following from a first RAN node via a serving cell: respective configurations for one or more LTM candidate target cells, and one or more security tokens associated with the LTM candidate target cells;
receiving an LTM cell switch command indicating a first one of the LTM candidate target cells, wherein the LTM cell switch command includes a security token;
comparing the security token received in the LTM cell switch command and the security token associated with the configuration of the first LTM candidate target cell; and
based on a mismatch between the compared security tokens, determining that the LTM cell switch command is invalid and performing one or more of the following operations:
   aborting the LTM cell switch procedure to the first LTM candidate cell, and
   sending the first RAN node a report about the mismatch between the compared security tokens.
      A2. The method of embodiment A1, wherein one of the following applies:
each configuration includes an associated security token, which is independent of the security tokens of other configurations; or
at least two of the configurations are associated with a common security token, which is received together with the at least two configurations.
   A3. The method of any of embodiments A1-A2, wherein determining that the LTM cell switch command is invalid is based on the mismatch between security tokens being one of the following:
an initial mismatch detected based on comparing security tokens; or
an Nth mismatch detected based on comparing security tokens, where N>1.
   A4. The method of any of embodiments A1-A3, wherein determining that the LTM cell switch command is invalid is further based on receiving, from the first RAN node or a second RAN node, an indication that the LTM cell switch command indicating the first LTM candidate target cell is invalid, illegitimate, and/or unintended.
   A5. The method of any of embodiments A1-A4, wherein the one or more operations performed based on the mismatch between the compared security tokens also include one or more of the following:
discarding the LTM cell switch command;
maintaining the UE's connection with the first RAN node via the serving cell; and
releasing all LTM candidate target cells associated with a third RAN node, from which the LTM cell switch command including the mismatched security token was received.
   A6. The method of any of embodiments A1-A5, further comprising:
after determining that the LTM cell switch command is invalid, receiving a subsequent LTM cell switch command that includes a further security token; and
determining that the subsequent LTM cell switch command is invalid based on the earlier determination that the LTM cell switch command is invalid.
   A7 The method of embodiment A6, wherein:
the subsequent LTM cell switch command indicates the first LTM candidate target cell; and
determining that the subsequent LTM cell switch command is invalid is independent of whether the further security token matches the security token associated with the configuration of the first LTM candidate target cell.
   A8. The method of embodiment A6, wherein:
the subsequent LTM cell switch command indicates a second one of the LTM candidate target cells and is received from a same RAN node as the LTM cell switch command; and
determining that the subsequent LTM cell switch command is invalid is independent of whether the further security token matches the security token associated with the configuration of the second LTM candidate target cell.
   A9. The method of any of embodiments A1-A8, wherein the report about the mismatch between the compared security tokens includes one or more of the following:
an identifier of the LTM cell switch command;
an identifier of the first LTM candidate target cell;
the security token received with the LTM cell switch command;
an identifier of a RAN node from which the UE received the LTM cell switch command; and
the security token associated with the configuration of the first LTM candidate target cell.
   A10. The method of any of embodiments A1-A9, further comprising, after sending the report, receiving one or more of the following from the first RAN node:
a further LTM cell switch command indicating the first LTM candidate target cell or a second one of the LTM candidate target cells;
one or more new security tokens to replace corresponding security tokens received with the configurations; and
an indication to release all of the configurations.
   A11. The method of embodiment A10, wherein the one or more new security tokens have greater lengths or sizes than the corresponding security tokens being replaced.
   A12. The method of any of embodiments Al-A11, further comprising, based on a match between the compared security tokens, executing the LTM cell switch to the first LTM candidate target cell in accordance with the command.
   A13. The method of any of embodiments A1-A12, wherein each of the LTM candidate target cells is a candidate to be used by the UE as one of the following: special cell (SpCell), primary cell (PCell), primary secondary cell group cell (PSCell), and secondary cell (SCell).
   B1. A method for a radio access network (RAN) node configured to support L1/L2-triggered mobility (LTM) of user equipment (UEs) in the RAN, the method comprising:
sending the following to a UE via a serving cell: respective configurations for one or more LTM candidate target cells, and one or more security tokens associated with the LTM candidate target cells; and
subsequently receiving from the UE a report about a mismatch detected by the UE between the following:
   the security token associated with the configuration of a first one of the LTM candidate target cells, and
   a security token received by the UE in an LTM cell switch command from a second RAN node.
      B2. The method of embodiment B1, wherein one of the following applies:
each configuration includes an associated security token, which is independent of the security tokens of other configurations; or
at least two of the configurations are associated with a common security token, which is sent together with the at least two configurations.
   B3. The method of any of embodiments B1-B2, wherein the mismatch indicated by the report is one of the following:
an initial mismatch detected by the UE based on comparing security tokens; or
an Nth mismatch detected by the UE based on comparing security tokens, where N>1.
   B4. The method of any of embodiments B1-B3, wherein the report about the mismatch between the compared security tokens includes one or more of the following:
an identifier of the LTM cell switch command received by the UE;
an identifier of the first LTM candidate target cell;
the security token received with the LTM cell switch command;
an identifier of a RAN node from which the UE received the LTM cell switch command; and
the security token associated with the configuration of the first LTM candidate target cell.
   B5. The method of any of embodiments B1-B4, further comprising, based on the report about the mismatch, sending to the UE one or more of the following:
a further LTM cell switch command indicating the first LTM candidate target cell or a second one of the LTM candidate target cells;
one or more new security tokens to replace corresponding security tokens received with the configurations; and
an indication to release all of the configurations.
   B6. The method of embodiment B5, wherein the one or more new security tokens have greater lengths or sizes than the corresponding security tokens being replaced.
   B7. The method of any of embodiments B1-B6, further comprising, based on the report about the mismatch, sending one or more of the following to another network node or function (NNF):
an identifier of the LTM cell switch command received by the UE;
an identifier of the first LTM candidate target cell;
the security token received with the LTM cell switch command;
an identifier of a RAN node from which the UE received the LTM cell switch command; and
the security token associated with the configuration of the first LTM candidate target cell.
   B8. The method of embodiment B7, wherein the other NNF is one of the following: a centralized unit (CU) associated with the RAN node; an NNF in a core network coupled to the RAN; or an operations/administration/maintenance (OAM) system coupled to the RAN.
   B9. The method of any of embodiments B1-B8, wherein each of the LTM candidate target cells is a candidate to be used by the UE as one of the following: special cell (SpCell), primary cell (PCell), primary secondary cell group cell (PSCell), and secondary cell (SCell).
   C1. A user equipment (UE) configured for L1/L2-triggered mobility (LTM) in a radio access network (RAN), the UE comprising:
communication interface circuitry configured to communicate with the RAN node via at least one serving cell; and
processing circuitry operably coupled to the communication interface circuitry, wherein the processing circuitry and communication interface circuitry are further configured to perform operations corresponding to any of the methods of embodiments A1-A13.
   C2. A user equipment (UE) configured for L1/L2-triggered mobility (LTM) in a radio access network (RAN), the UE being further configured to perform operations corresponding to any of the methods of embodiments A1-A13.
   C3. A non-transitory, computer-readable medium storing computer-executable instructions that, when executed by processing circuitry of a user equipment (UE) configured for L1/L2-triggered mobility (LTM) in a radio access network (RAN), configure the UE to perform operations corresponding to any of the methods of embodiments A1-A13.
   C4. A computer program product comprising computer-executable instructions that, when executed by processing circuitry of a user equipment (UE) configured for L1/L2-triggered mobility (LTM) in a radio access network (RAN), configure the UE to perform operations corresponding to any of the methods of embodiments A1-A13.
   D1. A radio access network (RAN) node configured to support L1/L2-triggered mobility (LTM) of user equipment (UE) in the RAN, the RAN node comprising:
communication interface circuitry configured to communicate with UEs via at least one serving cell; and
processing circuitry operably coupled to the communication interface circuitry, wherein the processing circuitry and communication interface circuitry are further configured to perform operations corresponding to any of the methods of embodiments B1-B9.
   D2. A radio access network (RAN) node configured to support L1/L2-triggered mobility (LTM) of user equipment (UE) in the RAN, the RAN node being further configured to perform operations corresponding to any of the methods of embodiments B1-B9.
   D3. A non-transitory, computer-readable medium storing computer-executable instructions that, when executed by processing circuitry of a radio access network (RAN) node configured to support L1/L2-triggered mobility (LTM) of user equipment (UE) in the RAN, configure the RAN node to perform operations corresponding to any of the methods of embodiments B1-B9.
   D4. A computer program product comprising computer-executable instructions that, when executed by processing circuitry of a radio access network (RAN) node configured to support L1/L2-triggered mobility (LTM) of user equipment (UE) in the RAN, configure the RAN node to perform operations corresponding to any of the methods of embodiments B1-B9.

1.-34. (canceled)

35. A method for a user equipment (UE) configured for layer-1/layer2 triggered mobility (LTM) in a radio access network (RAN), the method comprising:
receiving the following from a first RAN node via a serving cell: respective configurations for one or more LTM candidate target cells, and one or more security tokens associated with the LTM candidate target cells;
receiving an LTM cell switch command indicating a first one of the LTM candidate target cells, wherein the LTM cell switch command includes a security token;
comparing the security token received in the LTM cell switch command and the security token associated with the configuration of the first LTM candidate target cell, thereby detecting a match or a mismatch between the compared security tokens; and
performing one or more of the following operations based on detecting a mismatch between the compared security tokens:
sending the first RAN node a report about the detected mismatch between the compared security tokens, and
aborting or refraining from initiating an LTM cell switch procedure to the first LTM candidate target cell.

36. The method of claim 35, wherein one of the following applies:
each configuration includes an associated security token, which is independent of the security tokens of other configurations; or
at least two of the configurations are associated with a common security token, which is received together with the at least two configurations.

37. The method of claim 35, further comprising determining that the LTM cell switch command is invalid based on a detected mismatch between the compared security tokens being one of the following:
an initial mismatch detected based on comparing security tokens; or
an Nth mismatch detected based on comparing security tokens, where N>1.

38. The method of claim 37, wherein determining that the LTM cell switch command is invalid is further based on receiving, from the first RAN node or a second RAN node, an indication that the LTM cell switch command indicating the first LTM candidate target cell is invalid, illegitimate, and/or unintended.

39. The method of claim 37, further comprising:
after determining that the LTM cell switch command is invalid, receiving a subsequent LTM cell switch command that includes a further security token; and
determining that the subsequent LTM cell switch command is invalid based on the earlier determination that the LTM cell switch command is invalid.

40. The method of claim 35, wherein the one or more operations performed based on detecting the mismatch also include one or more of the following:
discarding the LTM cell switch command;
maintaining the UE's connection with the first RAN node via the serving cell; and
releasing all LTM candidate target cells associated with a third RAN node, from which the LTM cell switch command including the mismatched security token was received.

41. The method of claim 35, wherein the report about the detected mismatch includes one or more of the following:
an identifier of the LTM cell switch command;
an identifier of the first LTM candidate target cell;
the security token received with the LTM cell switch command;
an identifier of a RAN node from which the UE received the LTM cell switch command; and
the security token associated with the configuration of the first LTM candidate target cell.

42. The method of claim 35, further comprising, after sending the report, receiving one or more of the following from the first RAN node:
a further LTM cell switch command indicating the first LTM candidate target cell or a second one of the LTM candidate target cells;
one or more new security tokens to replace corresponding security tokens received with the configurations, wherein the one or more new security tokens have greater lengths or sizes than the corresponding security tokens being replaced; and
an indication to release all of the configurations.

43. A method for a radio access network (RAN) node configured to facilitate layer-1/layer-2 triggered mobility (LTM) of user equipment (UEs) in the RAN, the method comprising:
sending the following to a UE via a serving cell: respective configurations for one or more LTM candidate target cells, and one or more security tokens associated with the LTM candidate target cells; and
subsequently receiving from the UE a report about a mismatch detected by the UE between the following:
the security token associated with the configuration of a first one of the LTM candidate target cells, and
a security token received by the UE in an LTM cell switch command from a second RAN node.

44. The method of claim 43 wherein one of the following applies:
each configuration includes an associated security token, which is independent of the security tokens of other configurations; or
at least two of the configurations are associated with a common security token, which is sent together with the at least two configurations.

45. The method of claim 43, wherein the detected mismatch indicated by the report is one of the following:
an initial mismatch detected by the UE based on comparing security tokens; or
an Nth mismatch detected by the UE based on comparing security tokens, where N>1.

46. The method of claim 43, wherein the report about the detected mismatch includes one or more of the following:
an identifier of the LTM cell switch command received by the UE;
an identifier of the first LTM candidate target cell;
the security token received with the LTM cell switch command;
an identifier of a RAN node from which the UE received the LTM cell switch command; and
the security token associated with the configuration of the first LTM candidate target cell.

47. The method of claim 43, further comprising, based on the report about the detected mismatch, sending to the UE one or more of the following:
a further LTM cell switch command indicating the first LTM candidate target cell or a second one of the LTM candidate target cells;
one or more new security tokens to replace corresponding security tokens received with the configurations, wherein the one or more new security tokens have greater lengths or sizes than the corresponding security tokens being replaced; and
an indication to release all of the configurations.

48. User equipment (UE) configured for layer-1/layer-2 triggered mobility (LTM) in a radio access network (RAN), the UE comprising:
communication interface circuitry configured to communicate with a first RAN node via at least one serving cell; and
processing circuitry operably coupled to the communication interface circuitry, wherein the processing circuitry and communication interface circuitry are configured to:
receive the following from the first RAN node via the serving cell: respective configurations for one or more LTM candidate target cells, and one or more security tokens associated with the LTM candidate target cells;
receive an LTM cell switch command indicating a first one of the LTM candidate target cells, wherein the LTM cell switch command includes a security token;
compare the security token received in the LTM cell switch command and the security token associated with the configuration of the first LTM candidate target cell, thereby detecting a match or a mismatch between the compared security tokens; and
perform one or more of the following operations based on detecting the mismatch between the compared security tokens:
send the first RAN node a report about the detected mismatch between the compared security tokens, and
abort or refrain from initiating an LTM cell switch procedure to the first LTM candidate target cell.

49. The UE of claim 48, wherein the one or more operations performed based on detecting the mismatch also include one or more of the following:
discarding the LTM cell switch command;
maintaining the UE's connection with the first RAN node via the serving cell; and
releasing all LTM candidate target cells associated with a third RAN node, from which the LTM cell switch command including the mismatched security token was received.

50. The UE of claim 48, wherein the report about the detected mismatch includes one or more of the following:
an identifier of the LTM cell switch command;
an identifier of the first LTM candidate target cell;
the security token received with the LTM cell switch command;
an identifier of a RAN node from which the UE received the LTM cell switch command; and
the security token associated with the configuration of the first LTM candidate target cell.

51. The UE of claim 48, wherein the processing circuitry and communication interface circuitry are further configured to, after sending the report, receive one or more of the following from the first RAN node:
a further LTM cell switch command indicating the first LTM candidate target cell or a second one of the LTM candidate target cells;
one or more new security tokens to replace corresponding security tokens received with the configurations, wherein the one or more new security tokens have greater lengths or sizes than the corresponding security tokens being replaced; and
an indication to release all of the configurations.

52. Radio access network (RAN), node configured to facilitate layer-1/layer-2 triggered mobility (LTM) of user equipment (UEs) in the RAN, the RAN node comprising:
communication interface circuitry configured to communicate with UEs via at least one serving cell; and
processing circuitry operably coupled to the communication interface circuitry, wherein the processing circuitry and communication interface circuitry are configured to:
send the following to a UE via the serving cell: respective configurations for one or more LTM candidate target cells, and one or more security tokens associated with the LTM candidate target cells; and
subsequently receive from the UE a report about a mismatch detected by the UE between the following:
the security token associated with the configuration of a first one of the LTM candidate target cells, and
a security token received by the UE in an LTM cell switch command from a second RAN node.

53. The RAN node of claim 52, wherein the report about the detected mismatch includes one or more of the following:
an identifier of the LTM cell switch command;
an identifier of the first LTM candidate target cell;
the security token received with the LTM cell switch command;
an identifier of a RAN node from which the UE received the LTM cell switch command; and
the security token associated with the configuration of the first LTM candidate target cell.

54. The RAN node of claim 52, wherein the processing circuitry and communication interface circuitry are further configured to, based on the report about the detected mismatch, send to the UE one or more of the following:
a further LTM cell switch command indicating the first LTM candidate target cell or a second one of the LTM candidate target cells;
one or more new security tokens to replace corresponding security tokens received with the configurations, wherein the one or more new security tokens have greater lengths or sizes than the corresponding security tokens being replaced; and
an indication to release all of the configurations.
